(19) United States
(12) Patent Application Publication
(10) Pub. No.: US 2015/0148023 A1
(43) Pub. Date: May 28, 2015

(54) System and Method for Managing an Alarm Clock

(71) Applicant: Acer Inc., New Taipei City (TW)

(72) Inventor: Chia-Yun Chuang, New Taipei City (TW)

(21) Appl. No.: 14/333,549

(22) Filed: Jul. 17, 2014

(30) Foreign Application Priority Data
Nov. 22, 2013 (TW) 102142571

(51) Int. Cl. G04G 13/02; H04M 1/725; G04G 15/00

(52) U.S. Cl. CPC G04G 13/025; G04G 15/003; H04M 1/72566; H04M 1/72577
USPC 455/418; 368/9

(57) ABSTRACT

A system and a method for managing an alarm clock are disclosed. The method includes the follow steps: activating a periodic alarm clock setting; receiving an activation command of the periodic alarm clock setting; deactivating the periodic alarm clock setting according to the activation command and displaying a reactivation setting interface; receiving a reactivation time of the periodic alarm clock setting inputted by a user from the reactivation setting interface; and reactivating the periodic alarm clock setting automatically at the reactivation time of the periodic alarm clock setting.

### BACKGROUND OF THE INVENTION

1. Field of the Invention

The present invention relates to a system and a method for managing an alarm clock; more particularly, it relates to a system and a method for managing an alarm clock capable of automatically activating a deactivated alarm clock setting.

2. Description of the Related Art

Generally, office workers having regular working hours use alarm clocks to prevent oversleeping so as not to be late for work. In recent years, portable electronic apparatuses (such as smart phones) have been commonly used as alarm clocks. The portable electronic apparatus is combined with application programs and hardware components having an alarm clock function as a substitute for a conventional alarm clock apparatus. For the convenience of setting the alarm clock, currently an alarm clock application program allows a user to select a periodic alarm clock setting by him/herself. For example, the setting may trigger the alarm clock to ring at a specific time every day, or at a specific time on certain days every week (such as from Monday to Friday), so as to prevent the inconvenience of repeatedly setting the alarm clock.

The periodic alarm clock setting is convenient in several ways. However, if the user has a off day or does not need to get up early on a weekday, he or she has to execute the alarm clock application program to deactivate the periodic alarm clock setting so as to prevent the alarm clock from ringing at the set time. Afterwards, the user must then manually reactivate the periodic alarm clock setting at an appropriate time in order to return to the normal execution of the periodic alarm clock setting. However, if the user forgets to reactivate the periodic alarm clock setting prior to the working day, it is possible that the user may oversleep and be late for work because the alarm clock does not ring.

Therefore, there is a need to provide a system and a method for managing an alarm clock to mitigate and/or obviate the aforementioned problems.

### SUMMARY OF THE INVENTION

It is an object of the present invention to provide a method for managing an alarm clock capable of automatically activating a deactivated alarm clock setting.

It is another object of the present invention to provide a system for managing an alarm clock applying the abovementioned method.

To achieve the abovementioned objects, the method for managing an alarm clock of the present invention comprises the following steps: activating a periodic alarm clock setting; receiving a deactivation command of the periodic alarm clock setting; deactivating the periodic alarm clock setting according to the deactivation command and generating an activation setting interface; receiving a reactivation time of the periodic alarm clock setting inputted by a user from the reactivation setting interface; and reactivating the periodic alarm clock setting automatically at the reactivation time of the periodic alarm clock setting.

The system for managing an alarm clock of the present invention comprises an alarm clock control module and an alarm clock reactivation module. The alarm clock control module is used for activating a periodic alarm clock setting, wherein the alarm clock control module receives an activation command of the periodic alarm clock setting to deactivate the periodic alarm clock setting. The alarm clock reactivation module is used for generating a reactivation setting interface according to the activation command and for receiving a reactivation time of the periodic alarm clock setting inputted by a user from the reactivation setting interface. The alarm clock reactivation module notifies the alarm clock control module to reactivate the periodic alarm clock setting automatically at the reactivation time of the periodic alarm clock setting.

Therefore, when the user deactivates a periodic alarm clock setting, the user will be requested to set up a reactivation time of the periodic alarm clock setting according to the design of the present invention. The periodic alarm clock setting can be reactivated at the reactivation time, and the inconvenience caused due to the user forgetting to manually reactivate the periodic alarm clock setting can be thus avoided.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a system block diagram of an alarm clock management system according to the present invention.

FIG. 2 illustrates a flowchart of a method for managing an alarm clock according to a first embodiment of the present invention.

FIG. 3 illustrates a flowchart of the method for managing an alarm clock according to a second embodiment of the present invention.

FIG. 4 illustrates a flowchart of the method for managing an alarm clock according to a third embodiment of the present invention.

FIG. 5 illustrates a system block diagram of the alarm clock management system according to another embodiment of the present invention.

FIG. 6 illustrates a flowchart of the method for managing an alarm clock according to a fourth embodiment of the present invention.

FIG. 7 illustrates a flowchart of the method for managing an alarm clock according to a fifth embodiment of the present invention.

### DETAILED DESCRIPTION OF THE PREFERRED EMBODIMENT

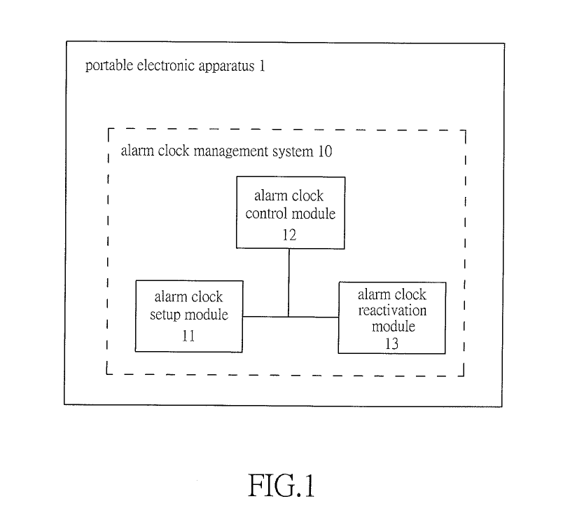

Please refer to FIG. 1. FIG. 1 illustrates a system block diagram of an alarm clock management system 10 according to the present invention. As shown in FIG. 1, the alarm clock management system 10 of the present invention is primarily applied in a portable electronic apparatus 1, such as, but not limited to, a smart phone, a portable computer, or any other equivalent electronic device having a screen display function.

The portable electronic apparatus 1 includes a storage unit, a processing unit and a display screen (not shown in figures). The storage unit can be a hard disk drive or a memory for storing an operating system and various kinds of application programs. The processing unit can be a central processing unit or a microprocessor for executing the operating system or each of the application programs according to commands inputted by a user, as well as for switching a usage mode (such as among normal, mute and vibration modes) of the apparatus. The display screen is used for displaying operating interfaces and contents of the operation system or each of the application programs. Because the internal components and functions of the portable electronic apparatus 1 are known designs, there is no need for further description.

As shown in FIG. 1, the alarm clock management system 10 of the present invention comprises an alarm clock setup module 11, an alarm clock control module 12 and an alarm clock reactivation module 13. In one embodiment, the alarm clock setup module 11 displays an operating interface via the display screen of the apparatus. A user can input commands and select desired dates and times for triggering an alarm sound of the alarm clock by the operating interface, so as to create an alarm clock setting. The present invention is primarily applicable for a periodic alarm clock setting or an alarm clock setting including a plurality of dates. The periodic alarm clock setting is used as a non-limiting example for describing the following embodiments of the present invention.

After the periodic alarm clock setting has been created, the alarm clock control module 12 activates the periodic alarm clock setting so as to trigger the alarm sound of the alarm clock at a specific time within a set time period. When the alarm sound of the alarm clock is triggered, the user can push a button of the apparatus or input a command to temporarily stop the alarm sound of the alarm clock, and the alarm sound of the alarm clock will be re-triggered at the next specific time. After the periodic alarm clock setting is activated, the alarm clock control module 12 can receive an activation command of the periodic alarm clock setting inputted by the user at any time so as to temporarily or permanently deactivate the periodic alarm clock setting. The abovementioned “permanently deactivate” is defined as any alarm sound of the alarm clock not being triggered at the specific time within the set time period after the user deactivates the periodic alarm clock setting. The main object of the design of the present invention is to achieve the effect of temporarily deactivating the periodic alarm clock setting; it means that the present invention can automatically activate the periodic alarm clock setting after the user deactivates the periodic alarm clock setting and then continue triggering the alarm sound of the alarm clock at the specific time within the set time period after reactivation of the periodic alarm clock setting.

The alarm clock reactivation module 13 is used for generating a reactivation setting interface according to the activation command inputted by the user. The reactivation setting interface provides contents such as dates and times later than the time point which the interface is generated such that the user can select and input a reactivation time of the periodic alarm clock setting. After the reactivation setting interface receives the reactivation time of the periodic alarm clock setting, the alarm clock reactivation module 13 notifies the alarm clock control module 12 to automatically reactivate the deactivated periodic alarm clock setting at the reactivation time.

The alarm clock setup module 11, the alarm clock control module 12 and the alarm clock reactivation module 13 can be, but are not limited to being, respectively composed of one or more hardware chips, software, firmware or any combination thereof.

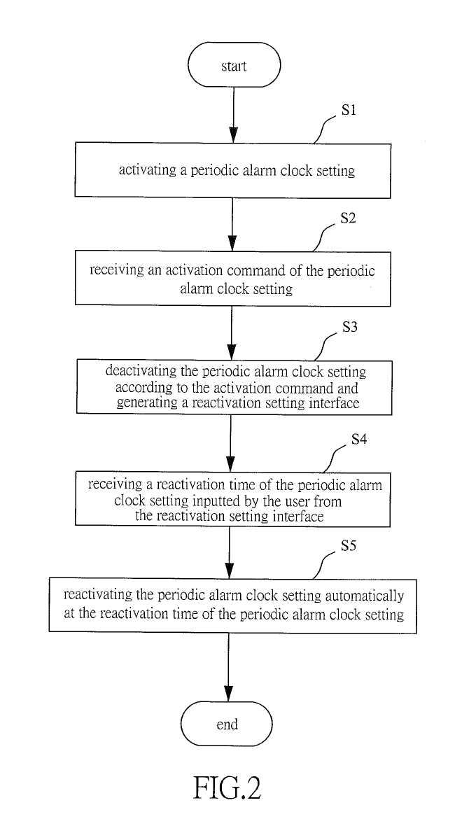

Please refer to FIG. 2, which illustrates a flowchart of a method for managing an alarm clock according to a first embodiment of the present invention. It is noted that although the present invention illustrates the method for managing an alarm clock with the alarm clock management system 10 shown in FIG. 1, the present invention is not limited to this. As shown in FIG. 2, the first embodiment of the method for managing an alarm clock of the present invention comprises steps S1 to S5. Please refer to the following description for explaining each of the steps in more details:

Step S1: Activating a Periodic Alarm Clock Setting.

After the user creates a periodic alarm clock setting by the alarm clock setup module 11, the alarm clock control module 12 then activates the periodic alarm clock setting, such that the alarm clock management system 10 of the present invention can trigger an alarm sound of the alarm clock at a specific time within a set time period. For example, the user creates the periodic alarm clock setting for triggering the alarm sound of the alarm clock at 7:00 AM every Monday through Friday, and the periodic alarm clock setting is activated immediately after being created.

Step S2: Receiving an Activation Command of the Periodic Alarm Clock Setting.

When the user needs to deactivate the periodic alarm clock setting, the user will input an activation command of the periodic alarm clock setting via an operating interface generated by the alarm clock setup module 11, and the activation command is then received and confirmed by the alarm clock control module 12. Continuing the above example, if the user takes a day off from work on Wednesday, he or she can input an activation command of the periodic alarm clock setting to the apparatus before the time of triggering the alarm sound of the alarm clock at 7:00 AM on Wednesday.

Step S3: Deactivating the Periodic Alarm Clock Setting According to the Activation Command and Generating a Reactivation Setting Interface.

After the alarm clock control module 12 receives and confirms the activation command, the alarm clock control module 12 deactivates the periodic alarm clock setting according to the activation command. At this time, the alarm clock control module 12 sends a notification to the alarm clock reactivation module 13. After the alarm clock reactivation module 13 is notified that the activation command of the periodic alarm clock setting has been received, it will generate a reactivation setting interface of the periodic alarm clock setting and display the reactivation setting interface on the display screen of the portable electronic apparatus 1. Continuing the above example, after the user inputs the activation command of the periodic alarm clock setting, the reactivation setting interface of the periodic alarm clock setting will be displayed on the display screen for operating.

Step S4: Receiving a Reactivation Time of the Periodic Alarm Clock Setting Inputted by the User from the Reactivation Setting Interface.

After the reactivation setting interface is displayed on the display screen, the user can input a reactivation time of the periodic alarm clock setting via the reactivation setting interface. The reactivation setting interface can provide content information such as dates and times later than the time which the reactivation setting interface is generated. The user can select and input a desired reactivation time for reactivating the periodic alarm clock setting. After the inputted reactivation time is received from the reactivation setting interface, the alarm clock reactivation module 13 will notify the alarm clock control module 12. Continuing the above example, if the user needs to go back to work on Thursday, the user can select any time point between 7:00 AM on Wednesday and 7:00 AM on Thursday as the reactivation time of the periodic alarm clock setting via the reactivation setting interface displayed after inputting the activation command. For example, the user may select 10:00 AM on Wednesday as the reactivation time. If the user does not input any reactivation time or directly closes the reactivation setting interface, it implies that the user has decided to permanently deactivate the periodic alarm clock setting.

Step S5: Reactivating the Periodic Alarm Clock Setting Automatically at the Reactivation Time of the Periodic Alarm Clock Setting.

After receiving the reactivation time of the periodic alarm clock setting from the abovementioned steps, the alarm clock control module 12 will resume the operation of the periodic alarm clock setting from the reactivation time until the periodic alarm clock setting is deactivated a next time. Continuing the above example, after the alarm clock control module 12 reactivates the previously deactivated periodic alarm clock setting at the reactivation time (i.e., 10:00 AM on Wednesday), the alarm sound of the alarm clocking function of the periodic alarm clock setting is therefore restored; it means that the periodic alarm clock setting will trigger the alarm sound of the alarm clock at 7:00 AM on Thursday, and will always trigger the alarm sound of the alarm clock at 7:00 AM from Monday through Friday within the following set time period.

Accordingly, when the user inputs the activation command to deactivate any of the periodic alarm clock settings, the alarm clock management system 10 of the present invention correspondingly generates a reactivation setting interface of the periodic alarm clock setting such that the user can decide whether to input the reactivation time to automatically reactivate the periodic alarm clock setting. The inconvenience caused by the user forgetting to manually reactivate the periodic alarm clock setting can thus be avoided.

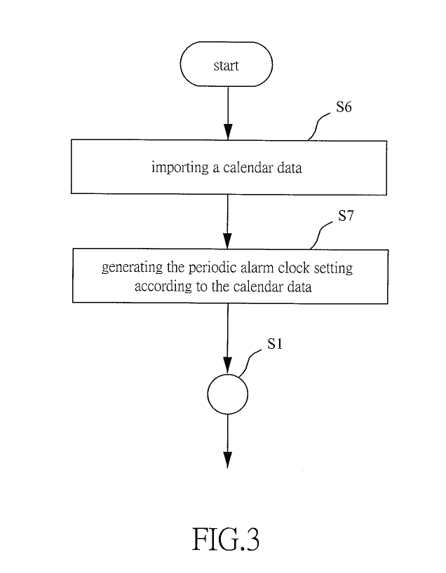

Please refer to FIG. 1 and FIG. 3 together. FIG. 3 illustrates a flowchart of the method for managing an alarm clock according to a second embodiment of the present invention. This embodiment describes another method for creating the periodic alarm clock setting. As shown in FIG. 3, the method for managing an alarm clock according to the second embodiment of the present invention further comprises steps S6 to S7 being executed prior to the abovementioned step S1. Each of the newly added steps will be described in detail hereinafter.

Step S6: Importing a Calendar Data.

In one embodiment, the alarm clock setup module 11 not only allows the user to input the periodic alarm clock setting but also imports a calendar data either automatically or manually by the user; then the alarm clock setup module 11 can generate a corresponding periodic alarm clock setting. The calendar data may be obtained from, but is not limited to, a calendar application program installed on the apparatus or a network (such as an annual calendar provided by a government facility or a company).

Step S7: Generating the Periodic Alarm Clock Setting According to the Calendar Data.

After importing the calendar data via step S6, the alarm clock setup module 11 automatically generates the periodic alarm clock setting according to the calendar data, or the user can determine the content of the periodic alarm clock setting by him/herself. For example, the alarm clock setup module 11 can retrieve holiday and non-holiday information from the calendar data. Therefore, the user needs only to set the specific time of triggering the alarm sound of the alarm clock or to apply a default specific time of the system for triggering the alarm sound of the alarm clock so that the system can automatically set the alarm sound of the alarm clock setting corresponding to non-holidays, as well as to avoid setting the alarm sound of the alarm clock setting corresponding to holidays.

Furthermore, after the calendar data has been imported, the user can also change or adjust the default alarm time of the alarm clock setting. For example, the user can manually cancel the alarm sound of the alarm clock on a scheduled day off or advance or delay the alarm time of a date having a specific event, thereby creating a personalized periodic alarm clock setting.

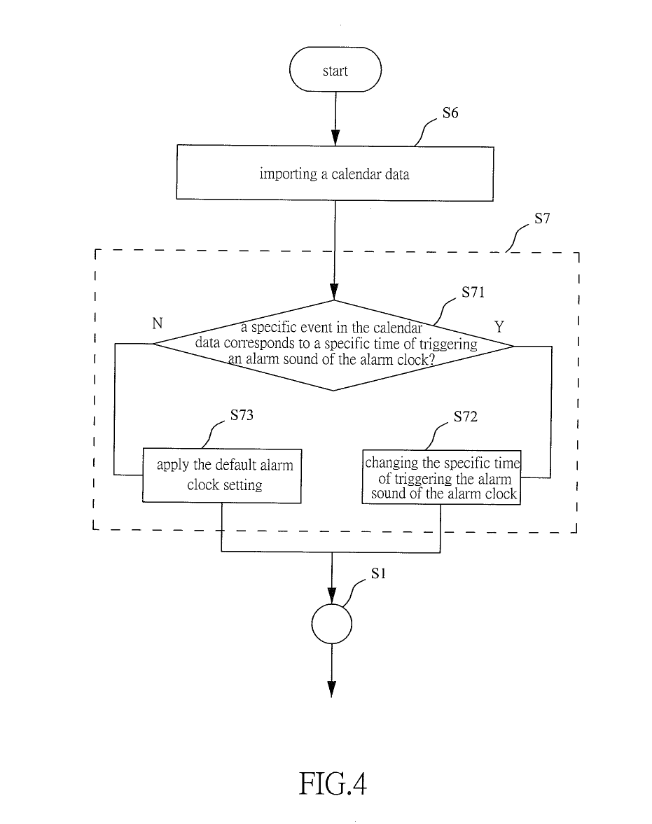

Please refer to FIG. 1 and FIG. 4 together. FIG. 4 illustrates a flowchart of the method for managing an alarm clock according to a third embodiment of the present invention. This embodiment describes an application case of automatically generating a periodic alarm clock setting according to the calendar data. As shown in FIG. 4, the method for managing an alarm clock of the present invention further includes steps S71 to S73 in step S7. Each of the newly added steps will be described in detail hereinafter.

Step S71: Determining Whether a Specific Event in the Calendar Data Corresponds to a Specific Time of Triggering an Alarm Sound of the Alarm Clock.

In another embodiment of the present invention, after the calendar data has been imported, the alarm clock setup module 11 can determine whether a specific event corresponds to (or overlaps with) a specific time of triggering an alarm sound of the alarm clock according to specific events recorded in the calendar data. The specific event is an event additionally recorded in the calendar, such as a day off, an office meeting, or a personal date scheduled by the user. Because the start time and end time of each of the specific events are also recorded in the calendar data, the alarm clock setup module 11 can determine whether each of the specific events corresponds to (or overlaps with) the specific time of triggering the alarm sound of the alarm clock according to the start time and end time of each of the specific events. If the specific event corresponds to the specific time of triggering an alarm sound of the alarm clock, step S72 is executed; otherwise, step S73 is executed to directly apply the default alarm clock setting.

Step S72: Changing the Specific Time of Triggering the Alarm Sound of the Alarm Clock.

If the alarm clock setup module 11 determines that the specific event corresponds to the specific time of triggering the alarm sound of the alarm clock, it means that the event time of the specific event has a conflict with the specific time of triggering the alarm sound of the alarm clock; as a result, the alarm clock setup module 11 needs to change the specific time of triggering the alarm sound of the alarm clock. For example, the specific time of triggering the alarm sound of the alarm clock is 8:00 AM. If the specific event is a non-holiday day off, the start time and end time of the specific event should be a whole day (i.e., from 00:00 to 23:59). Therefore, the alarm clock setup module 11 can directly delete the alarm sound of the alarm clock setting on the date having the specific event. In another case, if the specific event is an office meeting with its start time at 8:00 AM and its end time at 10:00 AM, the alarm clock setup module 11 can advance the specific time of triggering the alarm sound of the alarm clock (e.g., to 7:00 AM in the morning). However, the present invention is not limited to the abovementioned description.

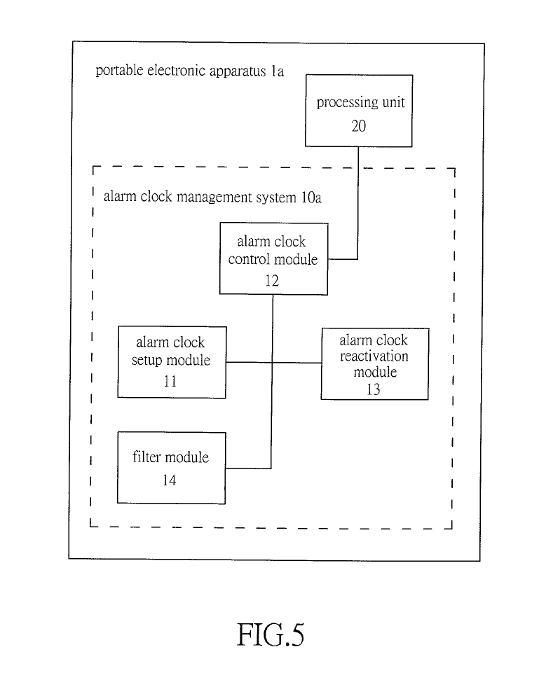

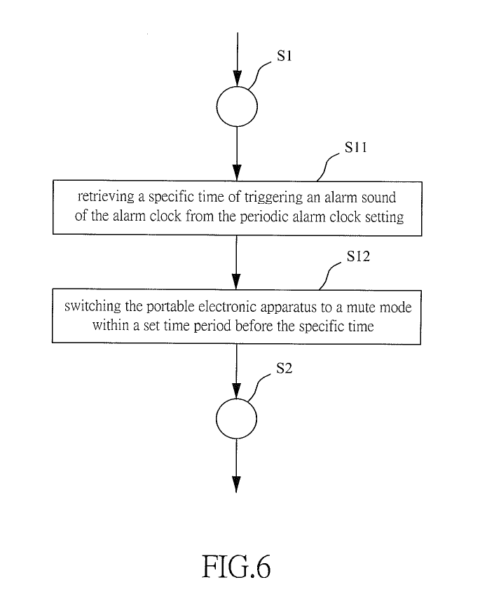

Please refer to FIG. 5 and FIG. 6 together. FIG. 5 illustrates a system block diagram of the alarm clock management system according to another embodiment of the present invention, and FIG. 6 illustrates a flowchart of the method for managing an alarm clock according to a fourth embodiment of the present invention. In this embodiment, the alarm clock management system 10a of the present invention combines functions of the portable electronic apparatus 1a. As shown in FIG. 6, the method for managing an alarm clock of the present invention further comprises steps S11 to S12 being executed after step S1. Each of the newly added steps will be described in detail hereinafter with reference to FIG. 5 and FIG. 6.

Step S11: Retrieving a Specific Time of Triggering an Alarm Sound of the Alarm Clock from the Periodic Alarm Clock Setting.

After the periodic alarm clock setting is created by the alarm clock management system 10a of the present invention, the alarm clock control module 12 will trigger the alarm sound of the alarm clock at the specific time within the set time period. Therefore, the alarm clock control module 12 can retrieve the specific time of triggering the alarm sound of the alarm clock from the periodic alarm clock setting.

Step S12: Switching the Portable Electronic Apparatus 1a to a Mute Mode within a Set Time Period Before the Specific Time.

When the user is sleeping, any sound or vibration generated by the portable electronic apparatus 1a receiving any notification messages or incoming calls may influence the sleep quality of the user. Therefore, in this embodiment, the alarm clock control module 12 can be used to set a mute mode time period in advance. After retrieving the specific time of triggering the alarm sound of the alarm clock, the alarm clock control module 12 will notify a processing unit 20 of the portable electronic apparatus 1a to switch the portable electronic apparatus 1a to a mute mode within the set time period before the specific time. In this embodiment, the mute mode can be an operating mode of deactivating the sound and/or vibration function of the portable electronic apparatus 1a. Accordingly, the present invention can ensure that the portable electronic apparatus 1a will not generate any sound or vibration within the set time period before the specific time of triggering the alarm sound of the alarm clock.

For example, the specific time of triggering the alarm sound of the alarm clock in the periodic alarm clock setting is 7:00 AM in the morning, and the set time period is 8 hours; therefore, according to the periodic alarm clock setting, the alarm clock control module 12 will notify the processing unit 20 of the portable electronic apparatus 1a to switch to the mute mode from 11:00 PM of the previous night to 7:00 AM of the morning. The alarm clock control module 12 will notify the processing unit 20 to switch the portable electronic apparatus 1a to a non-mute mode until 7:00 AM in the morning, and trigger the alarm sound of the alarm clock according to the periodic alarm clock setting.

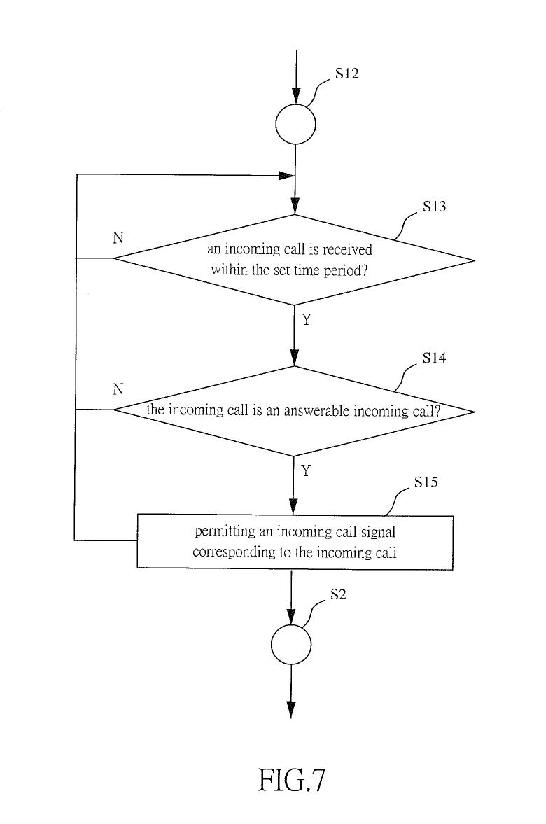

Please refer to FIG. 5 and FIG. 7 together. FIG. 7 illustrates a flowchart of the method for managing an alarm clock according to a fifth embodiment of the present invention. This fifth embodiment is a variation of the fourth embodiment. As shown in FIG. 7, the method for managing an alarm clock of the present invention further comprises steps S13 to S15 being executed after step S12. Each of the newly added steps will be described in detail hereinafter.

Step S13: Determining Whether an Incoming Call is Received within the Set Time Period.

The alarm clock management system 10a of the present invention further comprises a filter module 14. After the portable electronic apparatus 1a has been switched to the mute mode in step S12, the filter module 14 determines whether the portable electronic apparatus 1a receives an incoming call within the set time period before the specific time. If the portable electronic apparatus 1a receives an incoming call, step S14 is executed; otherwise, step S13 is repeatedly executed.

Step S14: Determining Whether the Incoming Call is an Answerable Incoming Call.

If an incoming call is received within the set time period, the filter module 14 will further determine whether the incoming call is an answerable incoming call. The filter module 14 can save at least one incoming call number inputted by the user in advance as a reference for comparison with the incoming call. If the filter module 14 determines that the number of the incoming call matches one of the saved incoming call numbers, the incoming call is an answerable incoming call; therefore, step S15 is executed. If the filter module 14 determines that the number of the incoming call does not match any of the saved incoming call numbers, the incoming call is an unanswerable incoming call. At this time, because the portable electronic apparatus 1a is in the mute mode, any sound or vibration in response to this incoming call will not be generated. After the incoming call ends, the filter module 14 further determines whether another incoming call is received; that is, the method will return to step S13.

Step S15: Permitting an Incoming Call Signal Corresponding to the Incoming Call.

If the filter module 14 determines that the incoming call is an answerable incoming call, the filter module 14 will notify the alarm clock control module 12. At this time, the alarm clock control module 12 will notify the processing unit 20 of the portable electronic apparatus 1a to temporarily switch the portable electronic apparatus 1a to the non-mute mode so as to permit the portable electronic apparatus 1a to provide an incoming call signal, such as a ring tone or vibration, corresponding to the incoming call; the user will be notified to answer the call accordingly. Furthermore, after the incoming call stops or the conversation of the incoming call ends, the alarm clock control module 12 will once again notify the processing unit 20 to switch back to the mute mode, and the filter module 14 will determine whether another incoming call is received; that is, the method will return to step S13. Accordingly, while the user is sleeping, the user not only can avoid disruption from unanswerable incoming calls or messages but also can avoid missing answerable incoming calls.

Although the present invention has been explained in relation to its preferred embodiments, it is to be understood that many other possible modifications and variations can be made without departing from the spirit and scope of the invention as hereinafter claimed.

What is claimed is:

1. A method for managing an alarm clock, applied in a portable electronic apparatus, the method comprising the following steps:
activating a periodic alarm clock setting;
receiving an activation command of the periodic alarm clock setting;
deactivating the periodic alarm clock setting according to the activation command and generating a reactivation setting interface;
receiving a reactivation time of the periodic alarm clock setting inputted by a user from the reactivation setting interface; and
reactivating the periodic alarm clock setting automatically at the reactivation time of the periodic alarm clock setting.

2. The method for managing an alarm clock as claimed in claim 1, further comprising the following steps:
importing a calendar data; and
generating the periodic alarm clock setting according to the calendar data.

3. The method for managing an alarm clock as claimed in claim 2, further comprising the following steps:
determining whether a specific event in the calendar data corresponds to a specific time of triggering an alarm sound of the alarm clock; and
if the specific event corresponds to the specific time of triggering the alarm sound of the alarm clock, changing the specific time of triggering the alarm sound of the alarm clock.

4. The method for managing an alarm clock as claimed in claim 1, further comprising the following steps:
retrieving a specific time of triggering an alarm sound of the alarm clock from the periodic alarm clock setting; and
switching the portable electronic apparatus to a mute mode within a set time period before the specific time.

5. The method for managing an alarm clock as claimed in claim 4, further comprising the following steps:
determining whether an incoming call is received within the set time period;
if the incoming call is received within the set time period, determining whether the incoming call is an answerable incoming call; and
if the incoming call is the answerable incoming call, permitting an incoming call signal corresponding to the incoming call.

6. A system for managing an alarm clock, applied in a portable electronic apparatus, the system comprising:
an alarm clock control module, used for activating a periodic alarm clock setting, the alarm clock control module receiving an activation command of the periodic alarm clock setting to deactivate the periodic alarm clock setting; and
an alarm clock reactivation module, used for generating a reactivation setting interface according to the activation command and for receiving a reactivation time of the periodic alarm clock setting inputted by a user from the reactivation setting interface; the alarm clock reactivation module notifies the alarm clock control module to reactivate the periodic alarm clock setting automatically at the reactivation time of the periodic alarm clock setting.

7. The system for managing an alarm clock as claimed in claim 6, further comprising an alarm clock setup module, wherein the alarm clock setup module is used for importing a calendar data and generating the periodic alarm clock setting according to the calendar data.

8. The system for managing an alarm clock as claimed in claim 7, wherein if the alarm clock setup module determines that a specific event in the calendar data corresponds to a specific time of triggering an alarm sound of the alarm clock, the alarm clock setup module changes the specific time of triggering the alarm sound of the alarm clock.

9. The system for managing an alarm clock as claimed in claim 6, wherein the alarm clock control module retrieves a specific time of triggering an alarm sound of the alarm clock from the periodic alarm clock setting and notifies the portable electronic apparatus to switch to a mute mode within a set time period before the specific time.

10. The system for managing an alarm clock as claimed in claim 9, further comprising a filter module, wherein if the filter module determines that an incoming call is received within the set time period and the incoming call is an answerable incoming call, the filter module permits the portable electronic apparatus to provide an incoming call signal corresponding to the incoming call.
